(19) United States
(12) Patent Application Publication
(10) Pub. No.: US 2017/0360007 A1
(43) Pub. Date: Dec. 21, 2017

(54) Pet Lease Device with a Buffering Function

(71) Applicant: Yung-Cheng Wu, Tainan (TW)

(72) Inventor: Yung-Cheng Wu, Tainan (TW)

(21) Appl. No.: 15/212,310

(22) Filed: Jul. 18, 2016

(30) Foreign Application Priority Data
Jun. 20, 2016 (TW) 105209201

(51) Int. Cl. A01K 27/00

(52) U.S. Cl. CPC A01K 27/003

(57) ABSTRACT

A pet lease device includes a first resilient section having a first portion and a second portion. A handle section includes a connecting end engaged with the first portion of the first resilient section and a handgrip. A tail section includes a first engaging end engaged with the second portion of the first resilient section and a connecting member. An optional coupling ring is fixed to the tail section. An optional restraining section includes a fixing end engaged with the handle section and an engaging end. When the engaging end of the restraining section is not engaged with the coupling ring, the first resilient section is permitted to stretch. When the engaging end of the restraining section engages with the coupling ring, the first resilient section is not permitted to stretch.

### BACKGROUND OF THE INVENTION

The present invention relates to a pet lease device with a buffering function and, more particularly, to a pet leash detachably coupled to an accessory worn on a peg, such as a dog, to control the behavior of the pet while giving the pet certain freedom.

Many people have dogs as pets. When it is desired to take a dog outside, a lease is attached to an accessory, such as a collar or a vest, worn on the dog to control the movement of the dog. Thus, the pet owner can control the movement of the dog by the leash while the dog moves with limited freedom.

Conventional leashes include rigid type and stretchable type. A rigid type leash is not elastic and provides a better control on the pet. However, the rigid leash does not provide any buffering effect, such that the hand of the pet owner could be injured by the pulling force imparted to the rigid leash by the pet during movement.

A stretchable leash is an elastic cord or a cord that can be coiled by a coiling device. Thus, the stretchable leash can elastically deform or change the length to provide a buffering effect, avoiding injury to the hand of the pet owner. However, the control on the pet is compromised due to elongation of the leash.

Thus, a need exists for a novel leash device that mitigates and/or obviates the above disadvantages.

### BRIEF SUMMARY OF THE INVENTION

In an aspect, a pet lease device includes a first resilient section having a first portion and a second portion. A handle section includes a connecting end engaged with the first portion of the first resilient section and a handgrip. A tail section includes a first engaging end engaged with the second portion of the first resilient section and a connecting member. An optional coupling ring is fixed to the tail section. An optional restraining section includes a fixing end engaged with the handle section and an engaging end. When the engaging end of the restraining section is not engaged with the coupling ring, the first resilient section is permitted to stretch. When the engaging end of the restraining section engages with the coupling ring, the first resilient section is not permitted to stretch.

The engaging end of the restraining section can include a coupling member selectively and detachably engaged with the coupling ring.

The first resilient section can further include a first elastic cord having first and second ends and two first engaging members. Each of the two first engaging members includes a barrel and an annular portion extending from an end of the barrel. The first end of the first elastic cord engages with the barrel of one of the two first engaging members to form the first portion of the first resilient section. The annular portion of the one of the two first engaging members engages with the connecting end of the handle section. The second end of the first elastic cord engages with the barrel of the other of the two first engaging members to form the second portion of the first resilient section. The annular portion of the other of the two first engaging members engages with the first engaging end of the tail section.

The first resilient section can further include a first protective sheath mounted around the first elastic cord. The first protective sheath includes two ends respectively fixed to the connecting end of the handle section and the first engaging end of the tail section. The first protective sheath has a length larger than a maximum length of the first elastic cord which has been stretched, permitting the first resilient section to elastically elongate when pulled.

In an example, the tail section includes a fixing section and a second resilient section. The fixing section is not elastically stretchable. The first engaging end is located on an end of the fixing section. The fixing section further includes a second engaging end. The second resilient section includes first and second ends. The first end of the second resilient section engages with the second engaging end of the fixing section. A connecting device engages with the second end of the second resilient section. The connecting device includes a connecting member adapted to detachably couple with an accessory worn on a pet.

The second resilient section can include a second elastic cord having first and second ends and two second engaging members. Each of the two second engaging members includes a barrel and an annular portion extending from an end of the barrel. The first end of the second elastic cord engages with the barrel of one of the two second engaging members to form the first end of the second resilient section. The annular portion of the one of the two second engaging members engages with the second engaging end of the fixing section. The second end of the second elastic cord engages with the barrel of the other of the two second engaging members to form the second end of the second resilient section. The annular portion of the other of the two second engaging members engages with the connecting device.

The second resilient section can further include a second protective sheath mounted around the second elastic cord. The second protective sheath includes two ends respectively fixed to the second engaging end of the fixing section and the connecting device. The second protective sheath has a length larger than a maximum length of the second elastic cord after stretching, permitting the second resilient section to elastically elongate when pulled.

In an example, the tail section includes a fixing section that is not elastically stretchable. The first engaging end is located on an end of the fixing section. The fixing section further includes a second engaging end. A connecting member is fixed to the second engaging end of the fixing section and is adapted to detachably couple with an accessory worn on a pet.

In a second aspect, a pet lease device includes a first resilient section having first and second portions and a fixing section having first and second engaging ends. The second engaging end of the fixing section engages with the first portion of the first resilient section. A handle section is disposed on the first engaging end of the fixing section. A connecting device is mounted to the second portion of the first resilient section. The connecting device includes a connecting member adapted to detachably couple with an accessory worn on a pet.

The first resilient section can further include a first elastic cord having first and second ends and two first engaging members. Each of the two first engaging members includes a barrel and an annular portion extending from an end of the barrel. The first end of the first elastic cord engages with the barrel of one of the two first engaging members to form the first portion of the first resilient section. The annular portion of the one of the two first engaging members engages with the second engaging end of the fixing section. The second end of the first elastic cord engages with the barrel of the other of the two first engaging members to form the second portion of the first resilient section. The annular portion of the other of the two first engaging members engaged with the connecting device.

The first resilient section further can include a first protective sheath mounted around the first elastic cord. The first protective sheath includes two ends respectively fixed to the second engaging end of the fixing section and the connecting device. The first protective sheath has a length larger than a maximum length of the first elastic cord which has been stretched, permitting the first resilient section to elastically elongate when pulled.

In a third aspect, a pet leash device includes a first resilient section having first and second portions. A handle section includes a connecting end engaged with the first portion of the first resilient section and a handgrip. A tail section includes a first engaging end engaged with the second portion of the first resilient section and a connecting member. The connecting member is adapted to detachably couple with an accessory worn on a pet.

The first resilient section can include a first elastic cord having first and second ends and two first engaging members. Each of the two first engaging members includes a barrel and an annular portion extending from an end of the barrel. The first end of the first elastic cord engages with the barrel of one of the two first engaging members to form the first portion of the first resilient section. The annular portion of the one of the two first engaging members engages with the connecting end of the handle section. The second end of the first elastic cord engages with the barrel of the other of the two first engaging members to form the second portion of the first resilient section. The annular portion of the other of the two first engaging members engages with the first engaging end of the tail section.

The first resilient section can further include a first protective sheath mounted around the first elastic cord. The first protective sheath includes two ends respectively fixed to the connecting end of the handle section and the first engaging end of the tail section. The first protective sheath has a length larger than a maximum length of the first elastic cord after stretching, permitting the first resilient section to elastically elongate when pulled.

The tail section can include a fixing section and a second resilient section. The fixing section is not elastically stretchable. The first engaging end is located on an end of the fixing section. The fixing section further includes a second engaging end. The second resilient section includes first and second ends. The first end of the second resilient section engages with the second engaging end of the fixing section. A connecting device engages with the second end of the second resilient section. The connecting device includes a connecting member adapted to detachably couple with an accessory worn on a pet.

The second resilient section can include a second elastic cord having first and second ends and two second engaging members. Each of the two second engaging members includes a barrel and an annular portion extending from an end of the barrel. The first end of the second elastic cord engages with the barrel of one of the two second engaging members to form the first end of the second resilient section. The annular portion of the one of the two second engaging members engages with the second engaging end of the fixing section. The second end of the second elastic cord engages with the barrel of the other of the two second engaging members to form the second end of the second resilient section. The annular portion of the other of the two second engaging members engages with the connecting device.

The second resilient section can further include a second protective sheath mounted around the second elastic cord. The second protective sheath includes two ends respectively fixed to the second engaging end of the fixing section and the connecting device. The second protective sheath has a length larger than a maximum length of the second elastic cord after stretching, permitting the second resilient section to elastically elongate when pulled.

The pet lease device can further include a restraining section having a fixing end engaged with the handle section and an engaging end having a coupling member. A coupling ring is fixed to the fixing section. The coupling ring is detachably coupled with the coupling member. When the engaging end of the restraining section is not engaged with the coupling ring, the first resilient section is permitted to stretch. When the engaging end of the restraining section engages with the coupling ring, the first resilient section is not permitted to stretch.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is a diagrammatic perspective view of a pet leash device of a first embodiment according to the present invention with a restraining section not engaged.

FIG. 2 is a cross sectional view taken along section line 2-2 of FIG. 1.

FIG. 3 is a cross sectional view taken along section line 3-3 of FIG. 1.

FIG. 4 is a diagrammatic perspective view of the pet leash device of the first embodiment with the restraining section engaged.

FIG. 5 is a diagrammatic view illustrating two pet leash devices, with the restraining section of one of the pet leashes not engaged, and with the restraining section of the other pet leash engaged.

FIG. 6 is a diagrammatic perspective view of a pet leash device of a second embodiment according to the present invention.

FIG. 7 is a diagrammatic perspective view of a pet leash device of a third embodiment according to the present invention.

All figures are drawn for ease of explanation of the basic teachings only; the extensions of the figures with respect to number, position, relationship, and dimensions of the parts to form the illustrative embodiments will be explained or will be within the skill of the art after the following teachings have been read and understood. Further, the exact dimensions and dimensional proportions to conform to specific force, weight, strength, and similar requirements will likewise be within the skill of the art after the following teachings have been read and understood.

Where used in the various figures of the drawings, the same numerals designate the same or similar parts. Furthermore, when the terms “first”, “second”, “end”, “portion”, “section”, “length”, and similar terms are used herein, it should be understood that these terms have reference only to the structure shown in the drawings as it would appear to a person viewing the drawings and are utilized only to facilitate describing the illustrative embodiments.

### DETAILED DESCRIPTION OF THE INVENTION

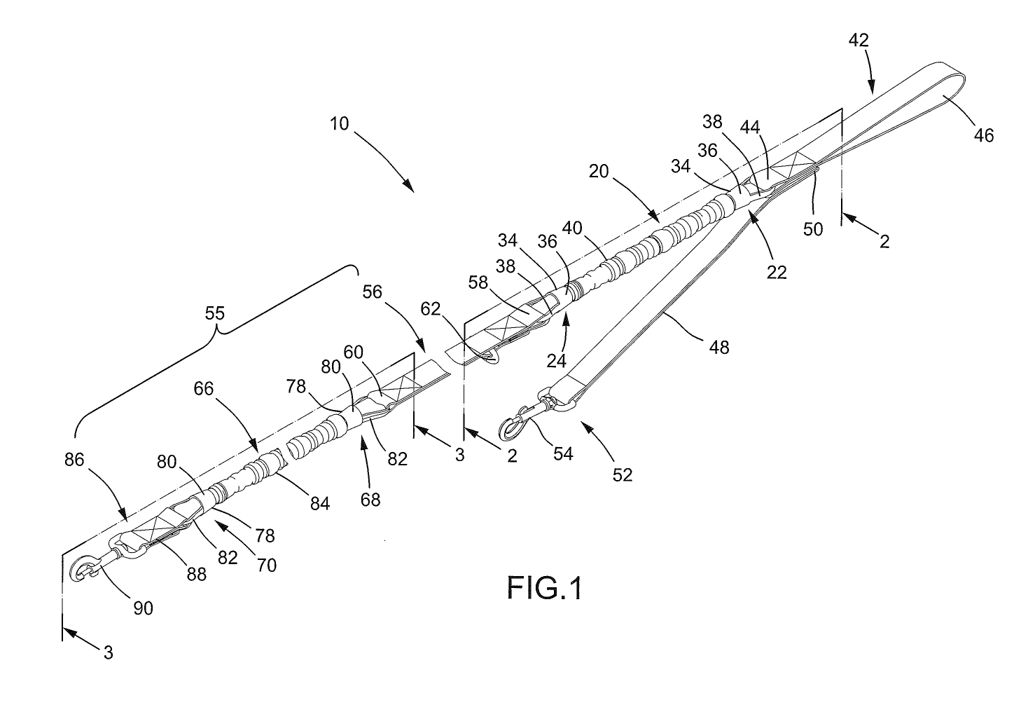

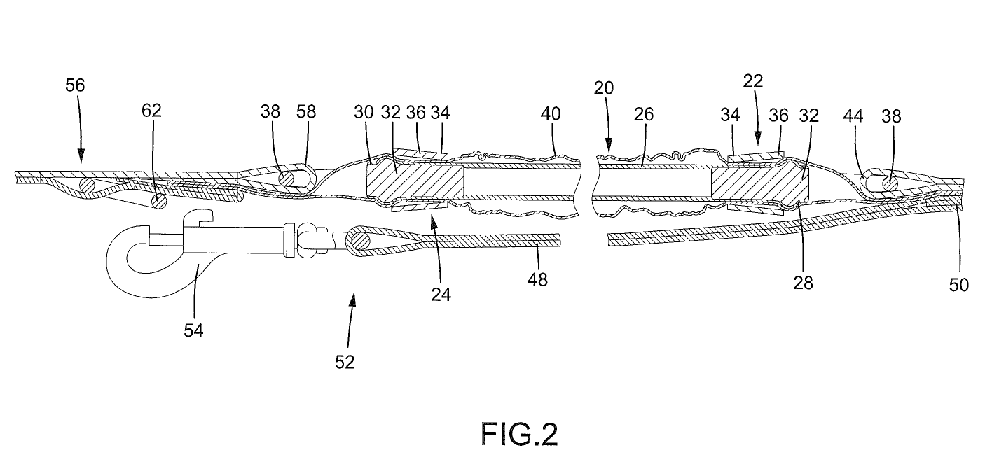

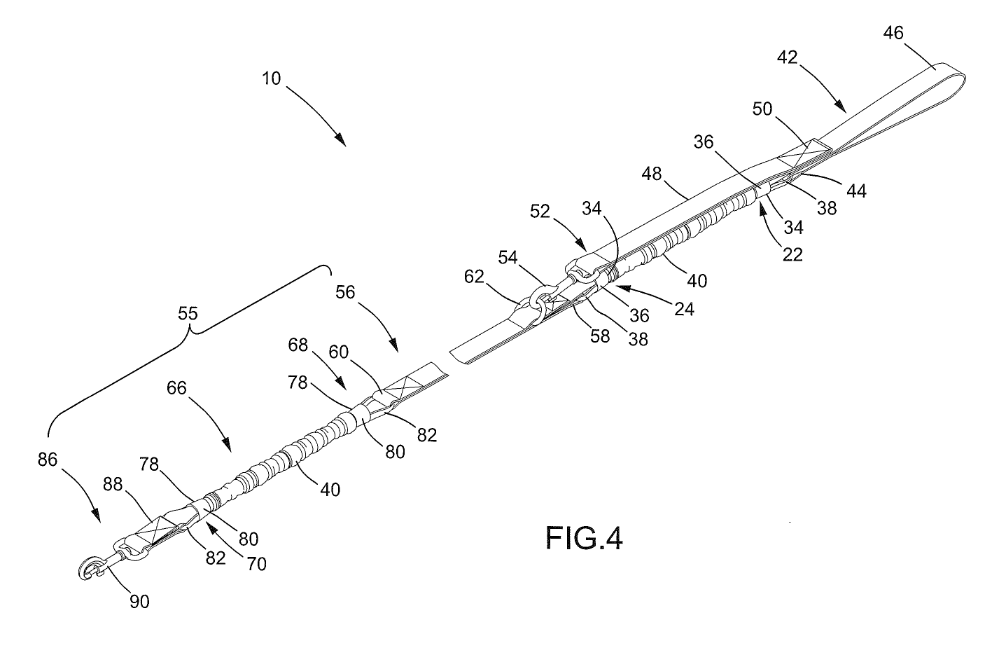

With reference to FIGS. 1-5, a pet lease device 10 of a first embodiment includes a first resilient section 20 that can elongate elastically. The first resilient section 20 includes a first portion 22 and a second portion 24. The first resilient section 20 further includes a first elastic cord 26 that can elastically elongate when subjected to a pulling force. The first elastic cord 26 includes a first end 28 and a second end 30 (see FIG. 2).

The first resilient section 20 includes two first engaging members 34. Each first engaging member 34 includes a barrel 36 that is conical and an annular portion 38 extending from an end of the barrel 36. The first end 28 of the first elastic cord 26 engages with the barrel 36 of one of the two first engaging members 34 to form the first portion 22 of the first resilient section 20. The second end 30 of the first elastic cord 26 engages with the barrel 36 of the other first engaging member 34 to form the second portion 24 of the first resilient section 20. Two first plugs 32 are respectively mounted in the first and second ends 28 and 30, such that the first and second ends 28 and 30 are stretched open to be slightly larger than an inner diameter of the barrel 36 of each first engaging member 34. As a result, the first and second ends 28 and 30 of the first elastic cord 26 engage with the barrels 36 of the two first engaging members 34 (FIG. 2). Thus, the first elastic cord 26 is stretched and elastically elongates when the two first engaging members 34 are moved away from each other.

The first resilient section 20 further includes a first protective sheath 40 mounted around the first elastic cord 26. The two first engaging members 34 are located between two ends of the first protective sheath 40 (see FIG. 2). A length of a portion of the first protective sheath 40 between the two first engaging members 34 is larger than the maximum length of the first elastic cord 26 after stretching. The maximum length of the first elastic cord 26 after stretching refers to a length of the first elastic cord 26 on the verge of breakage after the first elastic cord 26 is stretched by pulling the first and second ends 28 and 30 of the first elastic cord 26 in opposite directions. Thus, the first and second portions 22 and 24 of the first resilient section 20, when subjected to pulling forces in opposite directions, can elastically elongate without limitation by the first protective sheath 40.

The pet leash device 10 further includes a handle section 42. The handle section 42 includes a connecting end 44 and a handgrip 46. The connecting end 44 is coupled to the annular portion 38 of the first engaging member 34 of the first portion 22 of the first resilient section 20. One of the two ends of the first protective sheath 40 is fixed to the connecting end 44 of the handle section 42. In this embodiment, the handle section 42 is a stitched strap, and the handgrip 46 is a loop formed by a strap. Nevertheless, the handle section 42 can be in the form of a tube.

The pet leash device 10 further includes a restraining section 48. The restraining section 48 includes a fixing end 50 and an engaging end 52. The fixing end 50 is fixed to the connecting end 44 of the handle section 42. The engaging end 52 includes a coupling member 54 that can be of any desired form as conventional including but not limited to of a commercially available type.

The pet leash device 10 further includes a tail section 55 engaged with the second portion 24 of the first resilient section 20. The tail section 55 includes a fixing section 56. The fixing section 56 is not elastically stretchable. The fixing section 56 includes a first engaging end 58 engaged with the annular portion 38 of the first engaging member 34 of the second portion 24 and a second engaging end 60. The fixing section 56 further includes a coupling ring 62 fixed to a side thereof.

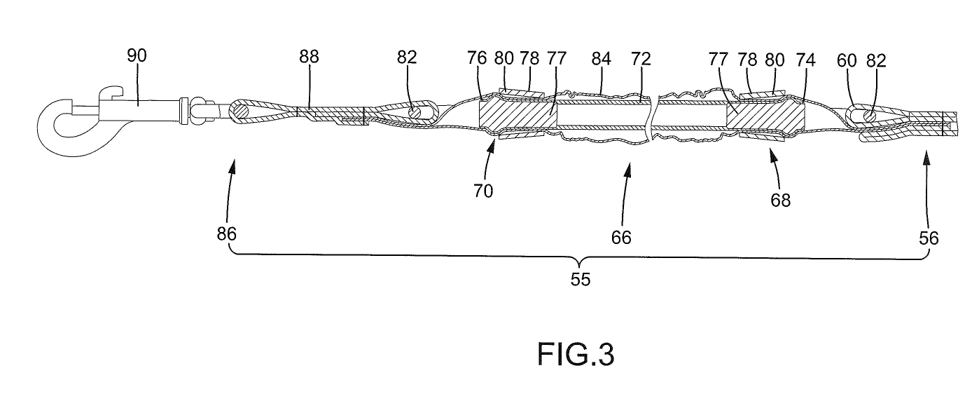

The tail section 55 includes a second resilient section 66 engaged with the fixing section 56. The second resilient section 66 includes a first end 68 engaged with the second engaging end 60 of the fixing section 56 and a second end 70. The second resilient section 66 further includes a second elastic cord 72 that elongates elastically when subjected to a pulling force. The second elastic cord 72 includes a first end 74 and a second end 76 (see FIG. 3).

The second resilient sections 66 further includes two second engaging members 78. Each second engaging members 78 includes a barrel 80 that is conical and an annular portion 82 extending from an end of the barrel 80. The first end 74 of the second elastic cord 72 engages with the barrel 80 of one of the two engaging members 78 to form the first end 68 of the second resilient section 66. The second end 76 of the second elastic cord 72 engages with the barrel 80 of the other second engaging member 78 to form the second end 70 of the second resilient sections 66.

Two second plugs 77 are respectively mounted in the first and second ends 74 and 76 of the second elastic cord 72, such that the first and second ends 74 and 76 of the second elastic cord 72 are stretched open to be slightly larger than an inner diameter of the barrel 80 of each second engaging member 78. As a result, the first and second ends 74 and 76 of the second elastic cord 72 engage with the barrels 80 of the two second engaging members 78 (FIG. 3). Thus, the second elastic cord 72 is stretched and elastically elongates when the two second engaging members 78 are moved away from each other.

The second elastic section 66 further includes a second protective sheath 84 mounted around the second elastic cord 72. The two second engaging members 78 are located between two ends of the second protective sheath 84 (see FIG. 3). A length of a portion of the second protective sheath 84 between the two second engaging members 78 is larger than the maximum length of the second elastic cord 72 after stretching. The maximum length of the second elastic cord 72 after stretching refers to a length of the second elastic cord 72 on the verge of breakage after the second elastic cord 72 is stretched by pulling the first and second ends 74 and 76 of the second elastic cord 72 in opposite directions. Thus, the first and second ends 68 and 70 of the second resilient section 66, when subjected to pulling forces in opposite directions, can elastically elongate without limitation by the second protective sheath 84.

The tail section 55 further includes a connecting device 86 engaged with the second resilient section 66. The connecting device 86 includes a connecting strap 88 and a connecting member 90. The connecting strap 88 is not elastically stretchable and engages with the annular portion 82 of the second end 70 of the second resilient section 66. The connecting member 90 is fixed to an end of the connecting strap 88 and can be of any desired form as conventional including but not limited to of a commercially available type.

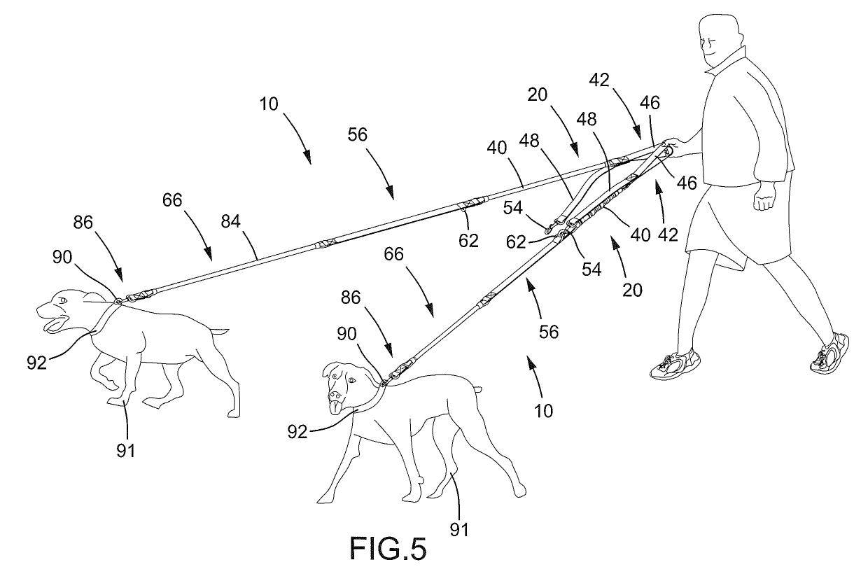

The connecting member 90 of the pet leash device 10 of the first embodiment can be detachably engaged with an accessory 92 on a pet 91, such as a dog. The accessory 92 can be a collar, a vest, etc. that is detachably engaged with a hook of the pet leash device 10. With reference to FIG. 5, a pet owner uses two pet leash devices 10 to carry two pets (dogs in this example) 91 each wearing an accessory 92 in the form of a collar. The connecting members 90 of the two pet leash devices 10 are connected to the accessories 92 on the pets 91. The coupling member 54 of the restraining section 48 on the left pet leash device 10 is not engaged with the coupling ring 62. Thus, the first and second resilient sections 20 and 66 on the left pet leash device 10 can elongate elastically under pulling. As for the right pet leash device 10, the coupling member 54 of the restraining section 48 engages with the coupling ring 62, such that only the second elastic section 66 can be elongate elastically under pulling, because the first resilient section 20 of the right pet leash device 10 is fixed by the restraining section 48.

The first and second resilient sections 20 and 66 of the pet leash device 10 of the first embodiment can elongate elastically when the pets 91 move, providing a buffering effect and reducing burden to the hand of the pet owner.

When desired, the coupling member 54 of the restraining section 48 on the right pet leash device 10 detachably engages with the coupling ring 62 to restrain elongation of the first resilient section 20, such that only the second resilient section 66 can restrain movement of the pet 91 while reducing the burden to the hand of the pet owner.

Furthermore, by the provision of the restraining section 48 to selectively restrain elongation of the first resilient section 20, the pet leash device 10 of the first embodiment can be used on dogs of different characteristics. For example, when the dog is tame (namely, a dog that would not run about), the restraining section 48 is not used, such that both of the first and second resilient sections 20 and 66 can elongate under pulling, providing the best buffering effect. On the other hand, if the dog is lively, the restraining section 48 is used to restrain elongation of the first resilient section 20, restraining movement of the pet while providing a suitable buffering effect.

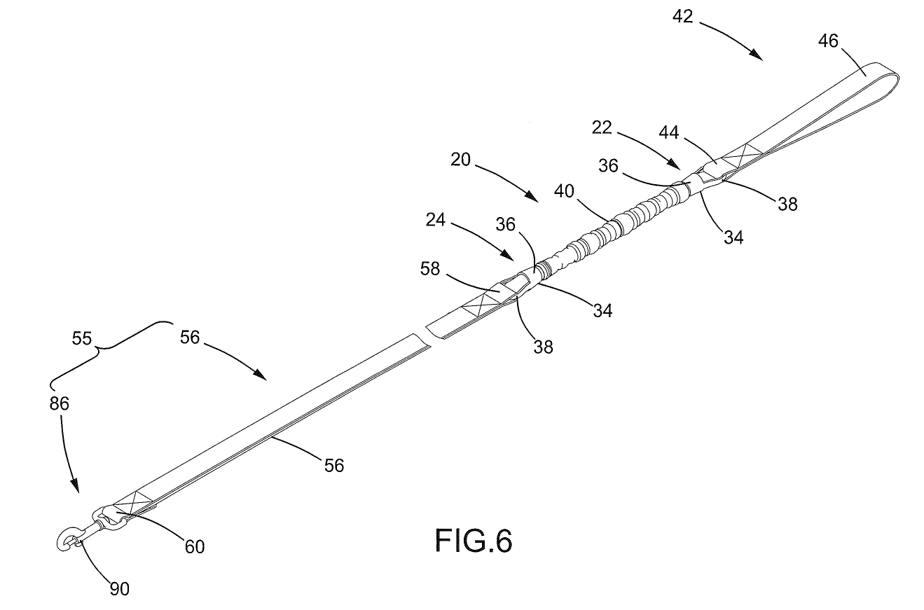

FIG. 6 shows a pet leash device 10 of a second embodiment. In comparison with the first embodiment, the tail section 55 of the pet leash device 10 of the second embodiment does not include the second resilient section 66. Furthermore, the pet leash device 10 of the second embodiment does not include the restraining section 48 and the coupling ring 62, and the connecting device 86 does not include the connecting strap 88. Instead, the first engaging end 58 of the fixing section 56 directly engages with the second portion 24 of the first resilient section 20. The connecting member 90 directly engages with the second engaging end 60 of the fixing section 56. In this state, the first resilient section 20 elastically elongate when subjected to pulling.

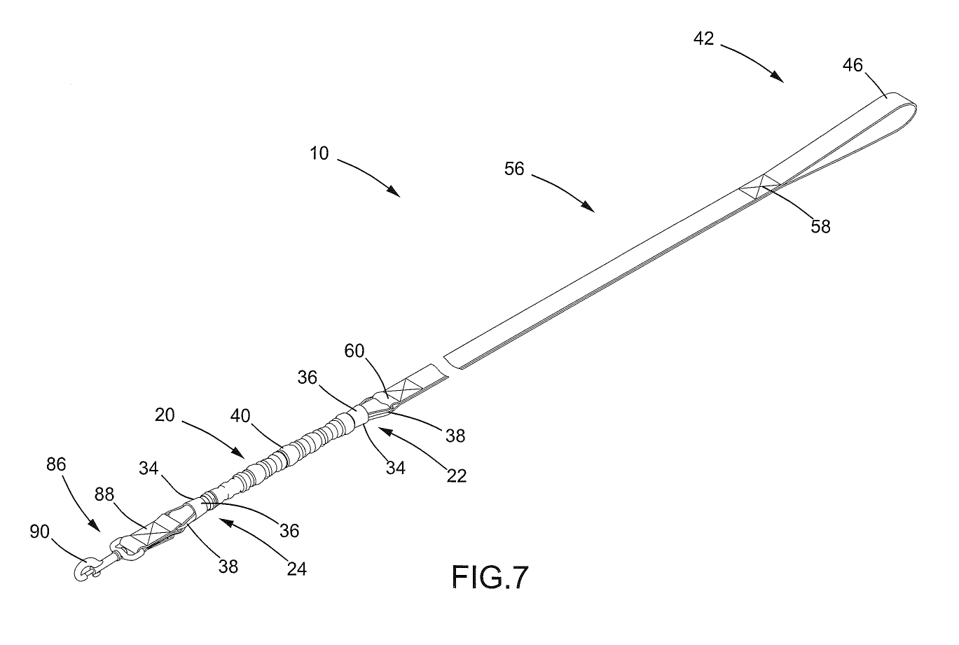

FIG. 7 shows a pet leash device 10 of a third embodiment. In comparison with the first embodiment, the pet leash device 10 of the third embodiment does not include the second resilient section 66, the restraining section 48, and the coupling ring 62. Furthermore, the second engaging end 60 of the fixing section 56 engages with the annular portion 38 of the first engaging member 34 of the first portion 22 of the first resilient section 20. The handle section 42 is located on the first engaging end 58 of the fixing section 56. The connecting device 86 engages with the annular portion 38 of the first engaging member 34 of the second portion 24. In this state, the first resilient section 20 elastically elongate when subjected to pulling.

The pet leash device 10 can effectively use the first and second resilient sections 20 and 66 (the first embodiment) or the first resilient section 20 (the second and third embodiments) to elastically elongate when subjected to pulling, thereby providing a buffering effect while reducing burden to the hand of the pet owner. Furthermore, the first and second resilient sections 20 and 66 have suitable lengths to control the elongation while restraining movement of the pets.

Now that the basic teachings of the pet leash device 10 have been explained, many extensions and variations will be obvious to one having ordinary skill in the art. For example, the first resilient section 20 of the pet leash device 10 in each embodiment does not have to include two first plugs 32. In this case, each of the first end 28 and the second end 30 of the first elastic cord 26 can be knotted to form a knot having a size lager than the inner diameter of the barrel 36 of the corresponding first engaging member 34 to fix the first and second ends 28 and 30 to the first engaging members 34. Likewise, the second resilient section 66 of the pet leash device 10 in each embodiment does not have to include two second plugs 77. In this case, each of the first end 74 and the second end 76 of the second elastic cord 72 can be knotted to form a knot having a size lager than the inner diameter of the barrel 80 of the corresponding second engaging member 78 to fix the first and second ends 74 and 76 to the second engaging members 78. Furthermore, the connecting device 86 of the first embodiment does not have to include the connecting strap 88, and the connecting member 90 directly engages with the annular portion 82 of the second engaging member 78 of the second resilient section 66. Furthermore, the connecting device 86 of the pet leash device 10 of the third embodiment does not have to include the connecting strap 88, and the connecting member 90 directly engages with the annular portion 38 of the second portion 24 of the first resilient section 20.

Thus since the illustrative embodiments disclosed herein may be embodied in other specific forms without departing from the spirit or general characteristics thereof, some of which forms have been indicated, the embodiments described herein are to be considered in all respects illustrative and not restrictive. The scope is to be indicated by the appended claims, rather than by the foregoing description, and all changes which come within the meaning and range of equivalency of the claims are intended to be embraced therein.

1. A pet lease device comprising:
a first resilient section including a first portion and a second portion;
a handle section including a connecting end engaged with the first portion of the first resilient section and a handgrip;
a tail section including a first engaging end engaged with the second portion of the first resilient section and a connecting member;
an optional coupling ring fixed to the tail section; and
an optional restraining section including a fixing end engaged with the handle section and an engaging end,
with the engaging end of the restraining section not engaged with the coupling ring, the first resilient section is permitted to stretch, and
with the engaging end of the restraining section engaged with the coupling ring, the first resilient section is not permitted to stretch.

2. The pet lease device as claimed in claim 1, with the engaging end of the restraining section including a coupling member selectively and detachably engaged with the coupling ring.

3. The pet lease device as claimed in claim 1, with the first resilient section further including:
a first elastic cord including a first end and a second end; and
two first engaging members, with each of the two first engaging members including a barrel and an annular portion extending from an end of the barrel, with the first end of the first elastic cord engaged with the barrel of one of the two first engaging members to form the first portion of the first resilient section, with the annular portion of the one of the two first engaging members engaged with the connecting end of the handle section, with the second end of the first elastic cord engaged with the barrel of another of the two first engaging members to form the second portion of the first resilient section, and with the annular portion of the other of the two first engaging members engaged with the first engaging end of the tail section.

4. The pet lease device as claimed in claim 3, with the first resilient section further including a first protective sheath mounted around the first elastic cord, with the first protective sheath including two ends respectively fixed to the connecting end of the handle section and the first engaging end of the tail section, and with the first protective sheath having a length larger than a maximum length of the first elastic cord which has been stretched, permitting the first resilient section to elastically elongate when pulled.

5. The pet lease device as claimed in claim 1, with the tail section including:
a fixing section, with the fixing section being not elastically stretchable, with the first engaging end located on an end of the fixing section, with the fixing section further including a second engaging end;
a second resilient section including a first end and a second end, with the first end of the second resilient section engaged with the second engaging end of the fixing section; and
a connecting device engaged with the second end of the second resilient section, with the connecting device including a connecting member adapted to detachably couple with an accessory worn on a pet.

6. The pet lease device as claimed in claim 5, with the second resilient section including:
a second elastic cord including a first end and a second end; and
two second engaging members, with each of the two second engaging members including a barrel and an annular portion extending from an end of the barrel, with the first end of the second elastic cord engaged with the barrel of one of the two second engaging members to form the first end of the second resilient section, with the annular portion of the one of the two second engaging members engaged with the second engaging end of the fixing section, with the second end of the second elastic cord engaged with the barrel of another of the two second engaging members to form the second end of the second resilient section, and with the annular portion of the other of the two second engaging members engaged with the connecting device.

7. The pet lease device as claimed in claim 6, with the second resilient section further including a second protective sheath mounted around the second elastic cord, with the second protective sheath including two ends respectively fixed to the second engaging end of the fixing section and the connecting device, and with the second protective sheath having a length larger than a maximum length of the second elastic cord after stretching, permitting the second resilient section to elastically elongate when pulled.

8. The pet lease device as claimed in claim 1, with the tail section including a fixing section, with the fixing section being not elastically stretchable, with the first engaging end located on an end of the fixing section, with the fixing section further including a second engaging end, with a connecting member fixed to the second engaging end of the fixing section, and with the connecting member adapted to detachably couple with an accessory worn on a pet.

9. A pet lease device comprising:
a first resilient section including a first portion and a second portion;
a fixing section including a first engaging end and a second engaging end, with the second engaging end of the fixing section engaged with the first portion of the first resilient section;
a handle section disposed on the first engaging end of the fixing section; and
a connecting device mounted to the second portion of the first resilient section, with the connecting device including a connecting member adapted to detachably couple with an accessory worn on a pet.

10. The pet lease device as claimed in claim 9, with the first resilient section further including:
a first elastic cord including a first end and a second end; and
two first engaging members, with each of the two first engaging members including a barrel and an annular portion extending from an end of the barrel, with the first end of the first elastic cord engaged with the barrel of one of the two first engaging members to form the first portion of the first resilient section, with the annular portion of the one of the two first engaging members engaged with the second engaging end of the fixing section, with the second end of the first elastic cord engaged with the barrel of another of the two first engaging members to form the second portion of the first resilient section, and with the annular portion of the other of the two first engaging members engaged with the connecting device.

11. The pet lease device as claimed in claim 10, with the first resilient section further including a first protective sheath mounted around the first elastic cord, with the first protective sheath including two ends respectively fixed to the second engaging end of the fixing section and the connecting device, and with the first protective sheath having a length larger than a maximum length of the first elastic cord which has been stretched, permitting the first resilient section to elastically elongate when pulled.

12. A pet leash device comprising:
a first resilient section including a first portion and a second portion;
a handle section including a connecting end engaged with the first portion of the first resilient section and a handgrip; and
a tail section including a first engaging end engaged with the second portion of the first resilient section and a connecting member, with the connecting member adapted to detachably couple with an accessory worn on a pet.

13. The pet lease device as claimed in claim 12, with the first resilient section including:
a first elastic cord including a first end and a second end; and
two first engaging members, with each of the two first engaging members including a barrel and an annular portion extending from an end of the barrel, with the first end of the first elastic cord engaged with the barrel of one of the two first engaging members to form the first portion of the first resilient section, with the annular portion of the one of the two first engaging members engaged with the connecting end of the handle section, with the second end of the first elastic cord engaged with the barrel of another of the two first engaging members to form the second portion of the first resilient section, and with the annular portion of the other of the two first engaging members engaged with the first engaging end of the tail section.

14. The pet lease device as claimed in claim 13, with the first resilient section further including a first protective sheath mounted around the first elastic cord, with the first protective sheath including two ends respectively fixed to the connecting end of the handle section and the first engaging end of the tail section, and with the first protective sheath having a length larger than a maximum length of the first elastic cord after stretching, permitting the first resilient section to elastically elongate when pulled.

15. The pet lease device as claimed in claim 12, with the tail section including:
a fixing section, with the fixing section being not elastically stretchable, with the first engaging end located on an end of the fixing section, with the fixing section further including a second engaging end;
a second resilient section including a first end and a second end, with the first end of the second resilient section engaged with the second engaging end of the fixing section; and
a connecting device engaged with the second end of the second resilient section, with the connecting device including a connecting member adapted to detachably couple with an accessory worn on a pet.

16. The pet lease device as claimed in claim 15, with the second resilient section including:
a second elastic cord including a first end and a second end; and
two second engaging members, with each of the two second engaging members including a barrel and an annular portion extending from an end of the barrel, with the first end of the second elastic cord engaged with the barrel of one of the two second engaging members to form the first end of the second resilient section, with the annular portion of the one of the two second engaging members engaged with the second engaging end of the fixing section, with the second end of the second elastic cord engaged with the barrel of another of the two second engaging members to form the second end of the second resilient section, and with the annular portion of the other of the two second engaging members engaged with the connecting device.

17. The pet lease device as claimed in claim 16, with the second resilient section further including a second protective sheath mounted around the second elastic cord, with the second protective sheath including two ends respectively fixed to the second engaging end of the fixing section and the connecting device, and with the second protective sheath having a length larger than a maximum length of the second elastic cord after stretching, permitting the second resilient section to elastically elongate when pulled.

18. The pet lease device as claimed in claim 15, further comprising:
a restraining section including a fixing end engaged with the handle section and an engaging end having a coupling member; and
a coupling ring fixed to the fixing section, with the coupling ring detachably coupled with the coupling member,
with the engaging end of the restraining section not engaged with the coupling ring, the first resilient section is permitted to stretch, and
with the engaging end of the restraining section engaged with the coupling ring, the first resilient section is not permitted to stretch.
